(19) United States
(12) Patent Application Publication
(10) Pub. No.: US 2026/0171524 A1
(43) Pub. Date: Jun. 18, 2026

(54) Method and System for Detecting Defect in Battery in Formation Process

(71) Applicant: SK On Co., Ltd., Seoul (KR)

(72) Inventors: Jong Hyeok LEE, Daejeon (KR); Na Eun GIL, Daejeon (KR); Hyeon Seob PARK, Daejeon (KR); Seul Gi SHIN, Daejeon (KR)

(21) Appl. No.: 19/414,545

(22) Filed: Dec. 10, 2025

(30) Foreign Application Priority Data
Dec. 17, 2024 (KR) 10-2024-0188291

(51) Int. Cl. H01M 10/42; H01M 10/04; H01M 10/44; H01M 10/52; H01M 50/609

(52) U.S. Cl. CPC H01M 10/4285; H01M 10/0481; H01M 10/446; H01M 10/52; H01M 50/609

(57) ABSTRACT

A method for detecting a defect in a battery in a formation process is disclosed. In some implementations, the method includes: charging or discharging at least one battery cell in the formation process; measuring a pressure in the at least one battery cell or a differentiation (dP/dQ) of the pressure with respect to charge when the at least one battery cell is charged or discharged; and generating data on whether the at least one battery cell has a defect based on the differentiation (dP/dQ).

### CROSS-REFERENCE TO RELATED APPLICATION(S)

This patent document claims the priority and benefits of Korean Patent Application No. 10-2024-0188291 filed on Dec. 17, 2024, the disclosure of which is incorporated herein by reference in its entirety.

### TECHNICAL FIELD

The disclosure and implementations disclosed in this patent document generally relate to a method and a system for detecting a defect in a battery in a formation process thereof.

### BACKGROUND

In a battery, a secondary battery has the convenience of being chargeable and dischargeable, unlike a primary battery, and thus has been identified as a power source for various mobile devices, electric vehicles, and the like. The secondary battery may include a battery cell in which an electrode assembly formed by stacking or winding a positive electrode plate, a negative electrode plate, and a separator in a roll shape is accommodated in a case. A plurality of battery cells may be stacked in a predetermined direction and accommodated in a battery module or a battery pack. The battery pack may include the plurality of battery modules.

Detecting a defect occurring in a battery during a battery manufacturing process is important in securing battery safety. Productivity of the battery manufacturing process may be improved as efficiency of battery defect detection increases.

### SUMMARY

The present disclosure may be implemented in some embodiments to provide a method and a system for detecting a defect in a battery in a formation process, the method and the system capable of efficiently detecting a defect (e.g., a foreign substance in the battery) occurring in the battery during the formation process thereof (e.g., efficiency achieved by utilizing a portion of a formation process system for detecting a battery defect and reduction of time required for defect detection).

In some embodiments of the present disclosure, provided is a method for detecting a defect in a battery in a formation process, the method including: charging or discharging at least one battery cell in the formation process; measuring a pressure in the at least one battery cell or a differentiation (dP/dQ) of the pressure with respect to charge when the at least one battery cell is charged or discharged; and generating data on whether the at least one battery cell has a defect based on the differentiation (dP/dQ).

The data may include data on whether negative-electrode salt occurs in the at least one battery cell, and the generating the data may include generating data indicating that negative-electrode salt occurs in a negative electrode of the at least one battery cell when the differentiation (dP/dQ) is greater than a reference value or a rate of change of differentiation (dP/dQ) is greater than a reference rate of change.

The generating the data may include generating the data indicating that negative-electrode salt occurs in the negative electrode of the at least one battery cell when the differentiation (dP/dQ) is greater than the reference value within a capacity range in which the differentiation (dP/dQ) is stabilized.

The generating the data may include generating the data indicating that negative-electrode salt occurs in the negative electrode of the at least one battery cell when the rate of change of differentiation (dP/dQ) is greater than the reference rate of change within a capacity range in which the differentiation (dP/dQ) is stabilized.

The differentiation (dP/dQ) may include a differentiation of the pressure with respect to charge of the charging, and the measuring may include monitoring the pressure and charge amount of the at least one battery cell when the at least one battery cell is charged, and measuring the differentiation by dividing a rate of change of pressure by a rate of change of charge amount.

The charging or discharging may include a press pre-charge (PPC) for performing the pressing and charging of the at least one battery cell together, and charging or discharging the at least one battery cell after the PPC, and the measuring may include measuring the pressure in the at least one battery cell or the differentiation (dP/dQ) when the PPC is performed.

The charging or discharging may include a pre-charge of the at least one battery cell, and charging or discharging of the at least one battery cell after the pre-charge, and the measuring may include measuring the pressure in the at least one battery cell or the differentiation (dP/dQ) of the pressure with respect to charge when at least one of the pre-charge, the charging or the discharging is performed.

The method may further include: formation finishing for performing at least one of aging for stabilizing the at least one battery cell or degassing for removing gas inside the at least one battery cell after the measuring.

The method may further include: controlling the formation finishing for a defective battery cell to be stopped when data indicating that the at least one battery cell is defective is generated in the generating the data.

The method may further include: manufacturing the at least one battery cell by coupling battery electrodes to a battery case, and injecting an electrolyte into the battery case prior to the charging or discharging.

In some embodiments of the present disclosure, provided is a system for detecting a defect in a battery in a formation process, the system including: a charge/discharge device for charging or discharging at least one battery cell undergoing the formation process; a pressure sensor for measuring a pressure in the at least one battery cell; and a controller for generating data on whether the at least one battery cell has a defect based on a differentiation (dP/dQ) of pressure with respect to charge.

The data may further include data on whether negative-electrode salt occurs in the at least one battery cell, and the controller may generate data indicating that negative-electrode salt occurs in a negative electrode of the at least one battery cell when the differentiation (dP/dQ) is greater than a reference value or a rate of change of differentiation (dP/dQ) is greater than a reference rate of change.

The controller may generate the data indicating that negative-electrode salt occurs in the negative electrode of the at least one battery cell when the differentiation (dP/dQ) is greater than the reference value within a capacity range in which the differentiation (dP/dQ) is stabilized.

The controller may generate the data indicating that negative-electrode salt occurs in the negative electrode of the at least one battery cell when the rate of change of differentiation (dP/dQ) is greater than the reference rate of change within a capacity range in which the differentiation (dP/dQ) is stabilized.

The differentiation (dP/dQ) may include a differentiation of the pressure with respect to charge of the charging, and the controller may monitor the pressure and charge amount of the at least one battery cell when the at least one battery cell is charged, and measures the differentiation by dividing a rate of change of pressure by a rate of change of charge amount.

The system may further include: a plurality of support plates between which the at least one battery cell is disposed; and a press device for pressing the plurality of support plates when the at least one battery cell is charged or discharged.

The pressure sensor may be implemented as a plurality of pressure sensors for measuring pressures in a plurality of regions of the at least one battery cell, and the controller may generate the data on whether the at least one battery cell has a defect based on the differentiation (dP/dQ) of a comprehensive pressure with respect to charge in the plurality of regions.

### BRIEF DESCRIPTION OF DRAWINGS

Certain aspects, features, and advantages of the present disclosure are illustrated by the following detailed description with reference to the accompanying drawings.

FIG. 1 is a flowchart illustrating battery processes including a formation process in a method and a system for detecting a defect in a battery in a formation process according to an embodiment of the present disclosure.

FIGS. 2A and 2B are flowcharts illustrating timings of detecting a defect (e.g., occurrence of negative-electrode salt) in the formation process included in the method and the system for detecting a defect in a battery in a formation process according to an embodiment of the present disclosure.

FIG. 2C is a flowchart illustrating the method for detecting a defect in a battery in a formation process according to an embodiment of the present disclosure.

FIGS. 3A and 3B are a side view and a plan view illustrating a structure for measuring a pressure in at least one battery cell in the method and the system for detecting a defect in a battery in a formation process according to an embodiment of the present disclosure.

FIG. 4A is a view illustrating a charge and discharge mechanism of a negative electrode in which negative-electrode salt does not occur.

FIG. 4B is a view illustrating a force generation mechanism according to charge and discharge of a negative electrode in which negative-electrode salt occurs.

FIG. 5A is a graph illustrating variations in force (dF) and voltage (dV) according to a variation in charge amount (dQ) during charge and discharge of the negative electrode in which negative-electrode salt does not occur.

FIG. 5B is a graph illustrating variations in force (dF) and voltage (dV) according to a variation in charge amount (dQ) during charge and discharge of the negative electrode in which negative-electrode salt occurs.

FIG. 5C is a graph illustrating that a variation in force (dF) according to a variation in charge amount (dQ) during charge and discharge significantly differs depending on whether negative-electrode salt occurs in a battery cell.

FIG. 5D is a flowchart illustrating a process for further specifying detection of occurrence of negative-electrode salt based on the graph of FIG. 5C in the method and the system for detecting a defect in a battery in a formation process according to an embodiment of the present disclosure.

FIGS. 6A and 6B are a side view and a plan view illustrating a structure for measuring pressures in a plurality of regions of a plurality of battery cells in the method and the system for detecting a defect in a battery in a formation process according to an embodiment of the present disclosure.

FIG. 7 is a side view illustrating pressures measured in a plurality of regions of at least one battery cell based on expansion of at least one battery cell according to charging in the method and the system for detecting a defect in a battery in a formation process according to an embodiment of the present disclosure.

### DETAILED DESCRIPTION

Features of the present disclosure disclosed in this patent document are described by example embodiments with reference to the accompanying drawings.

The present disclosure may be implemented in some embodiments to provide a method and a system for detecting a defect in a battery in a formation process.

Before describing embodiments of the present disclosure in detail, it should be understood that the terms or words used in the following description and claims are not to be limited to ordinary or dictionary meanings, and should be interpreted as meanings and concepts conforming to the spirit of the present disclosure, based on a principle that an inventor may properly define the concept of terms to describe the inventor's invention in the best manner.

The same reference numerals or symbols illustrated in the respective drawings denote parts or components that perform substantially the same function. For convenience of description and understanding, the same reference numerals or symbols may be used for description even in different embodiments.

In the following description, a term of a singular number includes its plural number unless the context clearly indicates otherwise. Terms such as “include” or “configure” and similar expressions are intended to specify the presence of the features, numbers, processes, operations, components, parts, or combinations thereof described in the specification, and are not intended to preclude the possibility of the presence or addition of one or more other features, numbers, processes, operations, components, parts, or combinations thereof.

In addition, in the following description, expressions such as upper side, upper portion, lower side, lower portion, side, front, and rear are used based on directions illustrated in the drawings, and it is previously stated that such expressions may be expressed differently when a direction of a corresponding object is changed.

In addition, in the following description and the claims, terms including ordinals such as “first” and “second” may be used to distinguish components from each other. Such ordinals are used to distinguish the same or similar components and should not be construed as limiting meanings of terms due to the use of the ordinals. For example, components coupled with the ordinals should not be construed as being limited in order of use or order of arrangement by their numbers. If necessary, the respective ordinals may be interchanged and used.

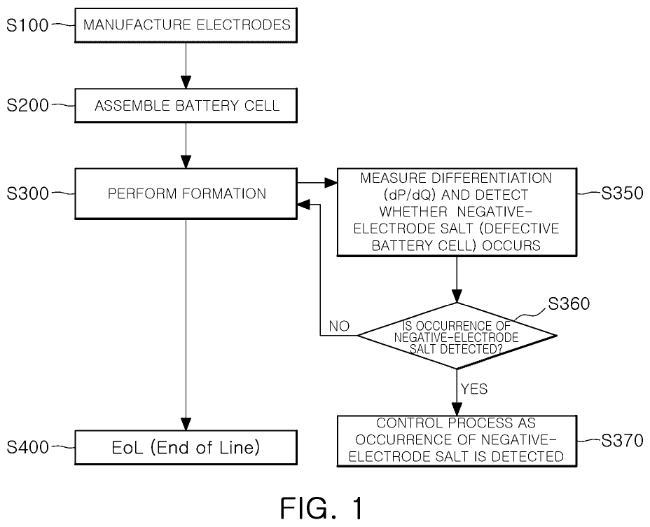

Referring to FIG. 1, a formation process (S300) included in a method and a system for detecting a defect in a battery in a formation process according to an embodiment of the present disclosure may be one process among sequentially performed battery processes (S100, S200, S300, and S400). The battery processes may include an electrode manufacturing process (S100), a battery cell assembly process (S200), a formation process (S300), and an End of Line (EoL) process (S400). The EoL process may be a post-process of a battery.

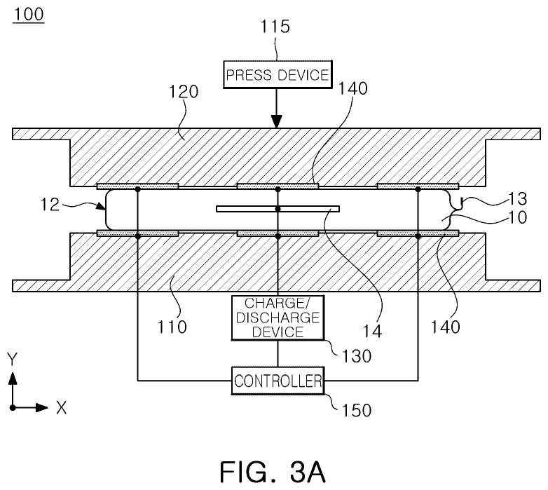

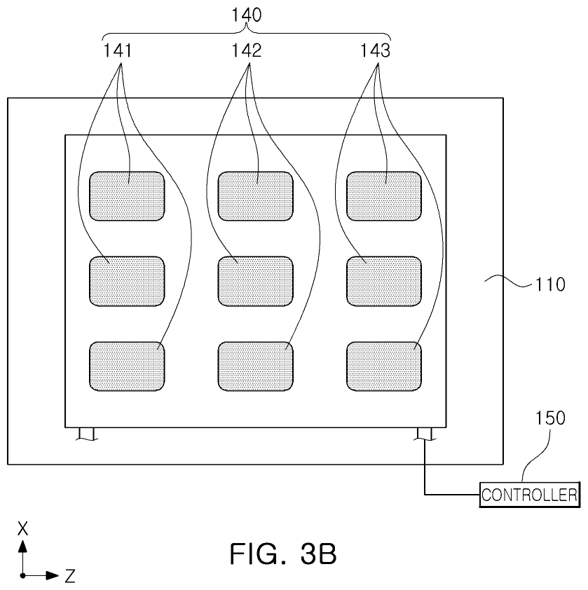

The electrode manufacturing process (S100) may include manufacturing battery electrodes 14 (see FIG. 3A) of at least one battery cell 10 (see FIG. 3A). For example, the electrode manufacturing process (S100) may include forming a slurry by mixing an active material, a conductive material, a binder, and a solvent, coating the slurry on both surfaces of a positive plate (e.g., aluminum plate or copper plate), rolling the coated positive plate, forming electrodes by slitting the coated and rolled positive plate, vacuum drying the electrodes, and manufacturing the battery electrodes 14 (see FIG. 3A) by notching the dried electrodes.

The battery cell assembly process (S200) may include manufacturing at least one battery cell 10 (see FIG. 3A) by coupling the battery electrodes 14 (see FIG. 3A) to a battery case 12 (see FIG. 3A), and injecting an electrolyte into the battery case 12 (see FIG. 3A) prior to the formation process (S300), and may be included in the method for detecting a defect in a battery in a formation process according to an embodiment of the present disclosure.

For example, the battery cell assembly process (S200) may include assembling tab-type battery electrodes 14 (see FIG. 3A) and a separator (e.g., a porous polymer film or a porous nonwoven fabric) in a specific manner (e.g., at least one of winding, stacking, jelly-roll type, Z-folding type, and stack-folding), connecting positive electrodes to each other or negative electrodes to each other by welding the tab-type battery electrodes 14 (see FIG. 3A) to each other, and disposing the welded battery electrodes 14 (see FIG. 3A) in the battery case 12 (see FIG. 3A) and injecting an electrolyte into the battery case 12 (see FIG. 3A). The battery case 12 (see FIG. 3A) may be a pouch-type case including a sealing portion 13 (see FIG. 3A), and may also be implemented as a cylindrical case or a prismatic case depending on design.

The formation process (S300) may include charging at least one battery cell 10 (see FIG. 3A) to allow at least one battery cell 10 (see FIG. 3A) assembled in the battery cell assembly process (S200) to have electrical characteristics. Here, a solid electrolyte interphase layer may be formed on a surface of the negative electrode of the battery electrode 14 (see FIG. 3A), and at least one battery cell 10 (see FIG. 3A) may thus have a microscopic structure capable of continuously performing an electrochemical reaction according to a voltage of the battery electrode 14 (see FIG. 3A).

For example, between the formation process (S300) and the EoL process (S400), a plurality of battery cells 10 (see FIG. 3A) may be stacked and assembled into one battery module. For example, the plurality of battery modules may be assembled into one battery pack or one battery rack.

Subsequent to the formation process (S300), the EoL process (S400) may include inspecting at least one battery cell having electrical characteristics. For example, the inspection may include at least one of inspection of electrical performance (e.g., capacity, charge/discharge voltage/current, internal resistance, or insulation resistance) of at least one battery cell, inspection of performance of a temperature sensor, inspection of performance of a battery management system (BMS), and inspection of an external appearance of the battery cell. A battery for which the EoL process (S400) is completed may be shipped for an eco-friendly vehicle such as an electric vehicle or for an energy storage system.

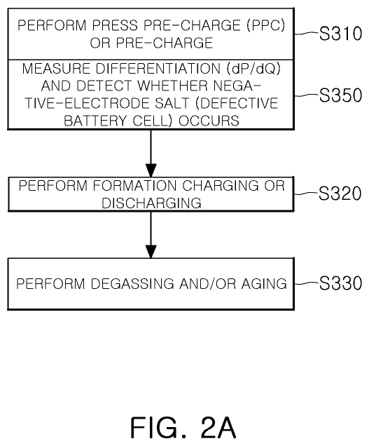

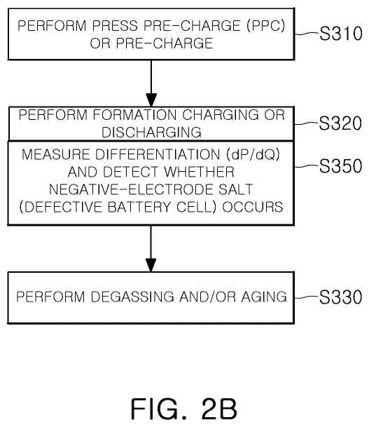

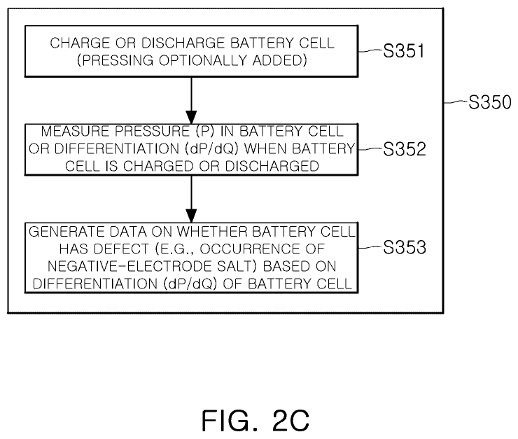

The method and the system for detecting a defect in a battery in a formation process according to an embodiment of the present disclosure may include detecting a defect (e.g., occurrence of negative-electrode salt) occurring in at least one battery cell 10 (see FIG. 3A) by measuring a pressure in at least one battery cell (10 of FIG. 3A) or a differentiation (dP/dQ) of the pressure with respect to charge (S350) during the formation process (S300). Depending on design, the method and the system for detecting a defect in a battery in a formation process may further include controlling the formation finishing (S330, illustrated in FIGS. 2A and 2B) for a defective battery cell to be stopped (S370) when data indicating that at least one battery cell 10 (see FIG. 3A) is defective (e.g., occurrence of negative-electrode salt) is generated (S360) in the detecting (S350). The processes (S350, S360, and S370) may be executed by a controller 150 (see FIG. 3A).

Referring to FIGS. 2A and 2B, the formation process (S300) in FIG. 1 may include a press pre-charge (PPC) (S310) for performing the pressing and charging of at least one battery cell 10 (see FIG. 3A) together, and charging or discharging of at least one battery cell 10 (see FIG. 3A) (S320) after the PPC (S310). The detecting of the defect (e.g., occurrence of negative-electrode salt) in at least one battery cell 10 (see FIG. 3A) (S350) may include measuring the pressure in at least one battery cell 10 (see FIG. 3A) or the differentiation (dP/dQ) of the pressure with respect to charge during the PPC (S310).

Alternatively, the formation process (S300) in FIG. 1 may include a pre-charge (S310) for pre-charging at least one battery cell 10 (see FIG. 3A), and charging or discharging (S320) of at least one battery cell 10 (see FIG. 3A) after the pre-charge (S310). The detecting of the defect (e.g., occurrence of negative-electrode salt) in at least one battery cell 10 (see FIG. 3A) may include measuring the pressure in at least one battery cell 10 (see FIG. 3A) or the differentiation (dP/dQ) of the pressure with respect to charge when at least one of the pre-charge (S310) or the charging or discharging (S320) is performed.

For example, the PPC or the pre-charge (S310) may include charging at least one battery cell 10 (see FIG. 3A) by a predetermined capacity (e.g., 20%) for the first time after the assembly of at least one battery cell 10 (see FIG. 3A). Here, an inside of at least one battery cell 10 (see FIG. 3A) may gradually be hardened. For example, a charge/discharge device 130 (see FIG. 3A) may charge at least one battery cell 10 (see FIG. 3A) in a constant current mode, and a voltage of at least one battery cell 10 (see FIG. 3A) may gradually increase according to charging. A press device 115 (see FIG. 3A) may be selectively used depending on a battery model and may press at least one battery cell 10 (see FIG. 3A) according to a predetermined pressure.

For example, the charging or discharging (S320) may include charging at least one battery cell 10 (see FIG. 3A) by more than the predetermined capacity (e.g., 20%), and depending on design, may further include discharging at least one battery cell 10 (see FIG. 3A) by the predetermined capacity (e.g., 20%). For example, when at least one battery cell 10 (see FIG. 3A) is pressed in the PPC or the pre-charge (S310), the charging or discharging (S320) may include charging or discharging at least one battery cell 10 (see FIG. 3A) after releasing pressing of the battery cell. Depending on design, aging and/or degassing may be included between the PPC or the pre-charge (S310) and the charging or discharging (S320). In this case, the charging or discharging (S320) may be defined as shipment charging.

Referring to FIGS. 2A and 2B, the formation process (S300) in FIG. 1 may further include the formation finishing (S330) for performing at least one of aging for stabilizing at least one battery cell 10 (see FIG. 3A) and degassing for removing gas inside at least one battery cell 10 (see FIG. 3A) after the detecting of the defect (e.g., occurrence of negative-electrode salt) in at least one battery cell 10 (see FIG. 3A) (S350).

For example, aging in the formation finishing (S330) may include leaving at least one battery cell 10 (see FIG. 3A) as it is (without charge/discharge) for a long time (e.g., several days) at a predetermined temperature (e.g., room temperature) and a predetermined pressure (e.g., atmospheric pressure). For example, aging may include at least one of aging for stabilizing electrical characteristics inside at least one battery cell 10 (see FIG. 3A) and aging for measuring characteristics of at least one battery cell 10 (see FIG. 3A). For example, degassing in the formation finishing (S330) may include releasing gas (e.g., gas occurring during electrical characteristics formation) inside at least one battery cell 10 (see FIG. 3A).

Referring to FIGS. 2C, 3A, and 3B, the method for detecting a defect in a battery in a formation process according to an embodiment of the present disclosure may include charging or discharging at least one battery cell 10 (S351) in the formation process, measuring a pressure (P) in at least one battery cell 10 or the differentiation (dP/dQ) of the pressure with respect to charge when at least one battery cell 10 is charged or discharged (S352), and generating data on whether at least one battery cell 10 has a defect based on the differentiation (dP/dQ) of the pressure with respect to charge (S353). Charge and discharge refer to charging or discharging.

Referring to FIGS. 3A and 3B, the system for detecting a defect in a battery in a formation process according to an embodiment of the present disclosure may include the charge/discharge device 130 for charging or discharging at least one battery cell 10 undergoing the formation process, a pressure sensor 140 for measuring a pressure in at least one battery cell 10, and the controller 150 for generating data on whether at least one battery cell 10 has a defect based on the differentiation (dP/dQ) of pressure with respect to charge. The charge/discharge device 130 may perform the charging or discharging (S351). The pressure sensor 140 and/or the controller 150 may perform the measuring of the pressure or the differentiation (dP/dQ) of the pressure with respect to charge (S352). The controller 150 may perform the generating the data (S353). Charge and discharge refer to charging or discharging.

Accordingly, the method and the system for detecting a defect in a battery in a formation process may efficiently detect a defect (e.g., occurrence of negative-electrode salt) in a battery in the formation process (S300 in FIG. 1) (e.g., efficiency achieved by utilizing a portion of the formation process system for detecting a battery defect), and may detect a battery defect early (e.g., earlier than the EoL process (S400 in FIG. 1)).

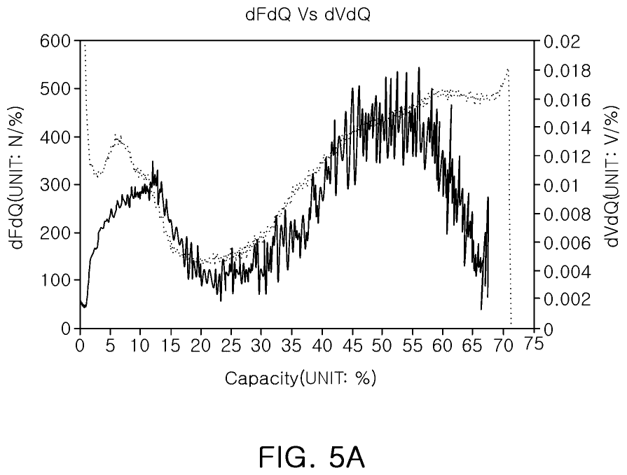

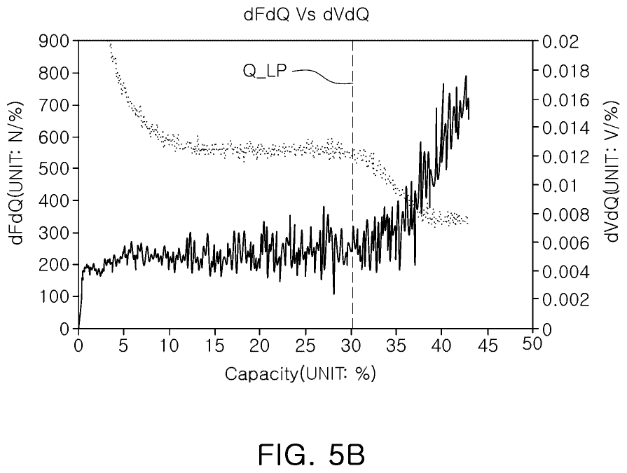

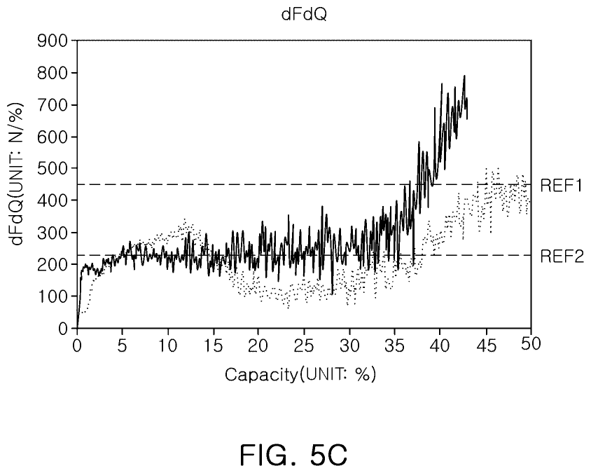

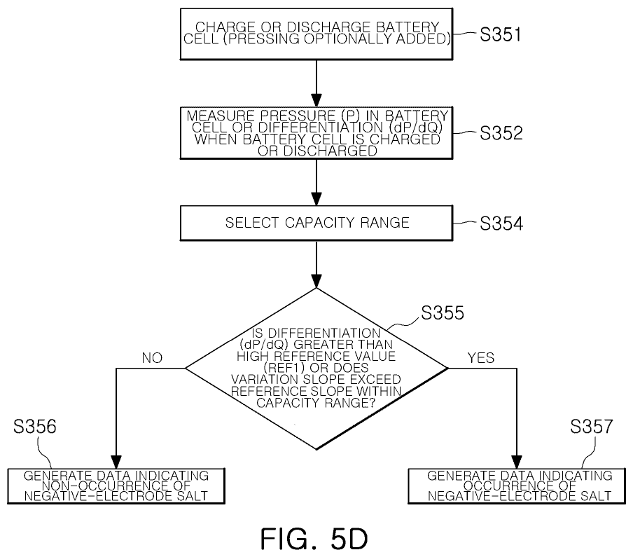

The differentiation (dP/dQ) (unit: (N/m²)/% or (N/m²)/(Ah)) may be a value obtained by dividing a rate of change of pressure (P) by a rate of change of charge amount (Q). The pressure (P) may be a value obtained by dividing a force (unit: N) by an area (unit: m²), and when the area is fixed (unit area assumed), the pressure (P) may be converted into a force. For example, the pressure sensor may measure a pressure by measuring a force applied to a predetermined area (constant area). Therefore, the differentiation (dP/dQ) and dF/dQ (see FIGS. 5A through 5C) may be freely converted to each other (by eliminating constants). A charge amount (Q) (unit: % or Ah) may correspond to a capacity of at least one battery cell 10. For example, a 100% charge amount (Q) may be a cumulative charge/discharge current (unit: Ah) accumulated while charging the battery cell 10 from 0% to 100% of a charge state, and may be calculated as a linear value. The unit of a charge amount (Q) may be selectively used between % and Ah, and % and Ah may be freely converted to each other (by eliminating constants). For example, the method and the system for detecting a defect in a battery in a formation process may directly measure a charge amount (Q) by measuring a charge/discharge current (unit: Ah), or may indirectly measure a charge amount (Q) by counting charge/discharge time when a charge/discharge current is known (e.g., constant current mode). For example, charge/discharge time may be used as a parameter or a substitute variable for calculating the differentiation (dP/dQ). For example, the controller 150 may include a timer for counting charge/discharge time, or may include a measurement circuit for measuring a charge/discharge current, thereby obtaining a charge amount (Q) of at least one battery cell 10.

For example, the differentiation (dP/dQ) may include a differentiation of the pressure with respect to charge in at least one battery cell 10, and the controller 150 may monitor the pressure and charge amount of at least one battery cell 10 during charging, and may measure a differentiation of charge amount during charging by dividing the rate of change of pressure by the rate of change of charge amount. For example, the controller 150 may calculate the differentiation of the pressure with respect to charge based on the measured pressure and charge amount only when at least one battery cell 10 is charged.

The system for detecting a defect in a battery in a formation process according to an embodiment of the present disclosure may further include a plurality of support plates 110 and 120 between which at least one battery cell 10 is disposed, and a press device 115 for pressing the plurality of support plates 110 and 120 when at least one battery cell 10 is charged or discharged. For example, the press device 115 may press at least one battery cell 10 according to a predetermined pressure by compressing the plurality of support plates 110 and 120 in a vertical direction. For example, the press device 115 may be used for the press pre-charge (PPC).

For example, at least one battery cell 10 may be formed by accommodating an electrode assembly including a positive plate, a negative plate, and a separator inside an outer case, injecting an electrolyte into the outer case, and then sealing the outer case. Here, electrodes 14 respectively connected to the positive plate and the negative plate may be exposed an outside of the outer case.

For example, the charge/discharge device 130 may receive power from at least one power supply for maintaining a direct-current voltage at a predetermined level. For example, the power supply may smooth a direct-current voltage whose level periodically changes, such as an output of at least one switched mode power supply (SMPS), through a capacitor and provide a substantially predetermined level of a direct-current voltage to the charge/discharge device 130. For example, the charge/discharge device 130 may be connected to electrodes 14 of at least one battery cell 10, apply a voltage to the electrodes 14, and output a current. For example, the charge/discharge device 130 may include a circuit (e.g., a regulation circuit) for controlling a magnitude of current to implement a constant current. For example, the circuit may be a circuit for monitoring current/voltage of at least one battery cell 10, comparing the current/voltage with predetermined current/voltage, and controlling the current/voltage based on a comparison result.

For example, the pressure sensor 140 may be in direct contact with at least one battery cell 10, or may measure pressure indirectly without contact (e.g., by disposing at least a portion of the support plate between the pressure sensor and the battery cell).

For example, the pressure sensor 140 may be implemented as at least one of a film-type pressure sensor, a force sensing resistor (FSR)-type pressure sensor, a strain gauge, and a load cell pressure sensor, and may be electrically connected to or communicate with the controller 150. For example, the pressure sensor 140 may have an electrical parameter (e.g., voltage, current, resistance) corresponding to a pressure. For example, a measurement circuit of the controller 150 may detect pressure information from the electrical parameter, and a computing system of the controller 150 may generate the data on whether at least one battery cell 10 has a defect based on the pressure information.

For example, the pressure sensor 140 may be implemented as a plurality of pressure sensors 141, 142, and 143 for measuring pressures in a plurality of regions of at least one battery cell 10, and the controller 150 may generate the data on whether at least one battery cell 10 has a defect based on the differentiation (dP/dQ) of a comprehensive pressure with respect to charge (e.g., an average pressure) in the plurality of regions. For example, the plurality of pressure sensors 141, 142, and 143 may be disposed on the plurality of support plates 110 and 120 to measure pressures in the plurality of regions of one battery cell among at least one battery cell 10. For example, the controller 150 may calculate a comprehensive pressure (e.g., an average pressure) from pressure data of the plurality of pressure sensors 141, 142, and 143. Depending on design, some of the plurality of pressure sensors 141, 142, and 143 may be omitted, and the plurality of pressure sensors 141, 142, and 143 may be integrated into one pressure sensor 140.

For example, the controller 150 may include a measurement circuit and/or a computing system. For example, the measurement circuit may be implemented as a digital multimeter, and the computing system may be implemented as a data acquisition system. For example, the measurement circuit may include an analog measurement circuit (e.g., a sampling circuit, a buffer circuit, an amplification circuit, or an analog-to-digital conversion circuit), and the computing system may include a processor (e.g., a central processing unit (CPU) or a graphics processing unit (GPU)), a memory (e.g., a volatile memory or a non-volatile memory), a recording medium, an input/output device, and a communication device. For example, the computing system may be at least a part of a manufacturing execution system (MES) or may be linked to the MES through the communication device. Alternatively, the controller 150 may include a programmable logic controller (PLC) and may control the press device 115 and/or the charge/discharge device 130.

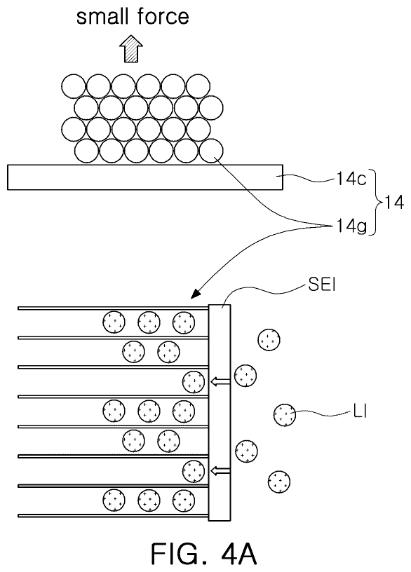

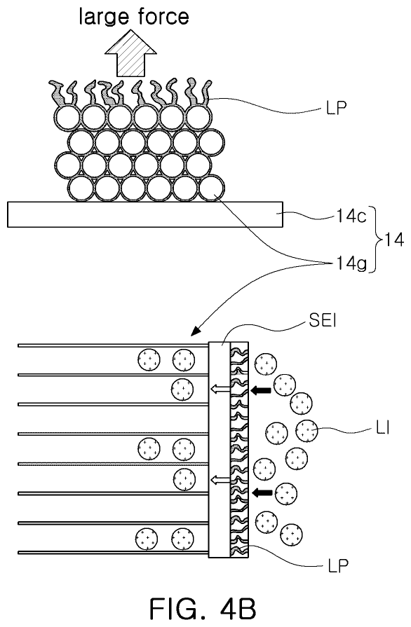

FIG. 4A is a view illustrating a charge and discharge mechanism of a negative electrode in which negative-electrode salt does not occur, and FIG. 4B is a view illustrating a force generation mechanism according to charge and discharge of a negative electrode in which negative-electrode salt occurs.

Referring to FIGS. 4A and 4B, a negative electrode of the electrode 14 may include a negative-electrode material 14g and a current collector 14c. For example, the negative-electrode material 14g may include graphite and/or silicon (Si), and the current collector 14c may include copper (Cu). The negative-electrode material 14g may include a solid electrolyte interphase (SEI) formed on a surface of the negative-electrode material 14g. During charge and discharge of the electrode 14, lithium ions (LI) may move in and out of the negative-electrode material 14g by an electrochemical reaction (e.g., intercalation) in the SEI. Referring to FIG. 4A, due to the movement of lithium ions (LI) in and out of the negative-electrode material 14g, the negative-electrode material 14g may generate a small force, thereby causing a small pressure in the battery cell.

Referring to FIG. 4B, the negative-electrode material 14g may further include negative-electrode salt formed on an outer surface of the SEI. For example, the negative-electrode salt may be lithium plating formed by precipitation of lithium ions (LI) in the SEI. The negative-electrode salt (LP) may operate to make the movement of lithium ions (LI) in and out of the negative-electrode material 14g less efficient. Here, the negative-electrode material 14g may generate a large force, thereby causing a large pressure in the battery cell.

A magnitude of the force generated by the negative-electrode material 14g per unit amount of lithium ions (LI) moving in and out of the negative-electrode material 14g may increase as the negative-electrode salt (LP) is formed thicker. The movement of lithium ions (LI) in and out of the negative-electrode material 14g may correspond to a charge amount (Q) of the battery cell and here, the force generated by the negative-electrode material 14g may correspond to the pressure (P) in the battery cell, the rate of change of pressure with respect to a change in charge amount (that is, a differentiation of the pressure with respect to charge) may increase as the negative-electrode salt (LP) is formed thicker.

Accordingly, the method and the system for detecting a defect in a battery in a formation process according to an embodiment of the present disclosure may generate data indicating whether the negative-electrode salt (LP) is formed to a predetermined thickness (e.g., a thickness that has a substantial effect on characteristics of the battery cell) based on the rate of change of pressure with respect to a change in charge amount (that is, a differentiation of the pressure with respect to charge), and may detect a defect in the battery cell based on the data.

FIG. 5A is a graph illustrating variations in force (dF) and voltage (dV) according to a variation in charge amount (dQ) during charge and discharge of a negative electrode in which negative-electrode salt does not occur, and FIG. 5B is a graph illustrating variations in force (dF) and voltage (dV) according to a variation in charge amount (dQ) during charge and discharge of a negative electrode in which negative-electrode salt occurs. Referring to FIGS. 5A and 5B, a solid curve represents a variation in force (dF/dQ) according to a variation in charge amount, and a dotted curve represents a variation in voltage (dV/dQ) according to a variation in charge amount.

As a charging rate of a battery cell increases, a possibility of occurrence of negative-electrode salt may increase. Accordingly, by charging a battery cell at a very high charging rate, negative-electrode salt may be intentionally formed in the battery cell. In addition, by charging a battery cell at a very low charging rate, occurrence of negative-electrode salt may be stably prevented. The graph of FIG. 5A shows experimental data obtained by charging a battery cell at a very low charging rate (C-rate) of 0.33 C without forming negative-electrode salt, and the graph of FIG. 5B shows experimental data obtained by charging a battery cell at a very high charging rate (C-rate) of 3.0 C while forming negative-electrode salt. In FIGS. 5A through 5C, a capacity corresponds to a charge amount, a unit of the capacity is %, a unit of voltage is V, and a unit of force is N.

Referring to FIGS. 5A and 5B, a variation in voltage (dV/dQ) according to a variation in charge amount was experimentally found to have an average value of about 0.012 (V/%) regardless of whether negative-electrode salt occurs. Therefore, a variation in voltage (dV/dQ) according to a variation in charge amount may be data that is difficult to use in determining occurrence of negative-electrode salt.

Referring to FIG. 5A, a variation in force (dF/dQ) according to a variation in charge amount of a battery cell without occurrence of negative-electrode salt was experimentally found to have an average value of about 300 (N/%). Referring to FIG. 5B, a variation in force (dF/dQ) according to a variation in charge amount of a battery cell with occurrence of negative-electrode salt steeply increased from about 300 (N/%) to about 700 (N/%) starting from a capacity exceeding 30% (Q_LP). Negative-electrode salt occurred in a state where the capacity exceeded 30% (Q_LP), a variation in force (dF/dQ) according to a variation in charge amount steeply increased from the state where negative-electrode salt occurred.

Therefore, compared with a variation in voltage (dV/dQ) according to a variation in charge amount, a variation in force (dF/dQ) according to a variation in charge amount may be more efficient data for determining whether negative-electrode salt occurs. That is, the method and the system for detecting a defect in a battery in a formation process according to an embodiment of the present disclosure may efficiently detect occurrence of negative-electrode salt of at least one battery cell 10 (see FIG. 3A) based on the differentiation (dP/dQ) of the pressure with respect to charge corresponding to a variation in force (dF/dQ) according to a variation in charge amount.

FIG. 5C is a graph illustrating that a variation in force (dF) according to a variation in charge amount (dQ) during charge and discharge significantly differs depending on whether negative-electrode salt occurs in a battery cell. A solid curve of FIG. 5C represents a variation in force (dF/dQ) according to a variation in charge amount of the battery cell illustrated in FIG. 5B that has occurrence of negative-electrode salt, and a dotted curve of FIG. 5C represents a variation in force (dF/dQ) according to a variation in charge amount of a battery cell illustrated in FIG. 5A that has no occurrence of negative-electrode salt.

Referring to FIG. 5C, as negative-electrode salt occurs, a variation in force (dF/dQ) according to a variation in charge amount may steeply increase and may have a greater peak value. Accordingly, in the generating the data (S353 in FIG. 2C), the controller 150 (see FIG. 3A) may generate data indicating that negative-electrode salt occurs in the negative electrode of at least one battery cell 10 (see FIG. 3A) when the differentiation (dP/dQ) of the pressure with respect to charge is greater than a reference value (e.g., REF1) or a rate of change of differentiation (a slope of a curve of a graph excluding minor variations) is greater than a reference rate of change. Accordingly, the method and the system for detecting a defect in a battery in a formation process may detect that negative-electrode salt in at least one battery cell 10 (see FIG. 3A) is formed to have a predetermined thickness (e.g., a thickness that has a substantial effect on characteristics of the battery cell) or more. Data on whether a defect is detected by the method and the system for detecting a defect in a battery in a formation process may include data on whether negative-electrode salt occurs in at least one battery cell 10 (see FIG. 3A).

FIG. 5D is a flowchart illustrating a process of further specifying detection of occurrence of negative-electrode salt based on the graph of FIG. 5C in the method and the system for detecting a defect in a battery in a formation process according to an embodiment of the present disclosure. Referring to FIGS. 5C and 5D, in the generating the data (S353 in FIG. 2C), the controller 150 (see FIG. 3A) may select a capacity range in which the differentiation (dP/dQ) of the pressure with respect to charge is stabilized (S354), check whether the differentiation (dP/dQ) is greater than a reference value (e.g., REF1) or whether a rate of change of a differentiation (dP/dQ) (a slope of a curve of a graph) is greater than the reference rate of change (S355), and based on a result of the checking, may generate data of non-occurrence of negative-electrode salt in at least one battery cell 10 (see FIG. 3A) (S356) or may generate data of occurrence of negative-electrode salt in at least one battery cell 10 (see FIG. 3A) (S357).

For example, in the generating the data (S353 in FIG. 2C), the controller 150 (see FIG. 3A) may select a capacity in which the differentiation (dP/dQ) of the pressure with respect to charge becomes greater than a low reference value REF2 as a minimum value (e.g., 5%) of a capacity range, select a maximum value (e.g., 50%) of the capacity range increased by a predetermined capacity from the minimum value (e.g., 5%), and detect whether the differentiation (dP/dQ) becomes greater than a high reference value REF1 or whether a variation slope of the differentiation (dP/dQ) becomes greater than a predetermined slope. For example, a unit range of capacity (horizontal axis) for calculating a variation slope of the differentiation (dP/dQ) may be equal to or larger than a predetermined range (e.g., 1%), and fine variations within the unit range of capacity (horizontal axis) may be excluded in a process of calculating the variation slope of the differentiation (dP/dQ).

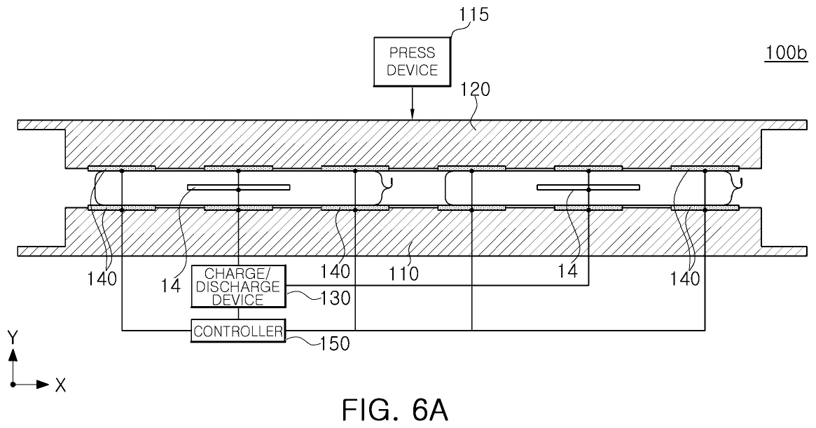

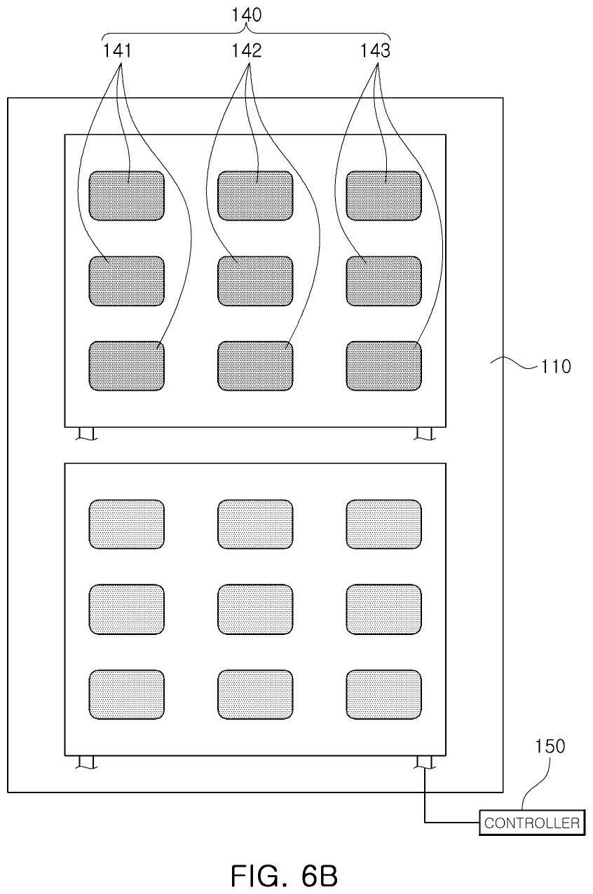

Referring to FIGS. 6A and 6B, at least one battery cell 10 (see FIG. 3A) may include a plurality of battery cells, and the plurality of pressure sensors 141, 142, and 143 may be disposed on the plurality of support plates 110 and 120 to measure a pressure in each of the plurality of battery cells. For example, a size of each of the plurality of support plates 110 and 120 may be larger than a size of each of the plurality of support plates 110 and 120 of FIGS. 3A and 3B.

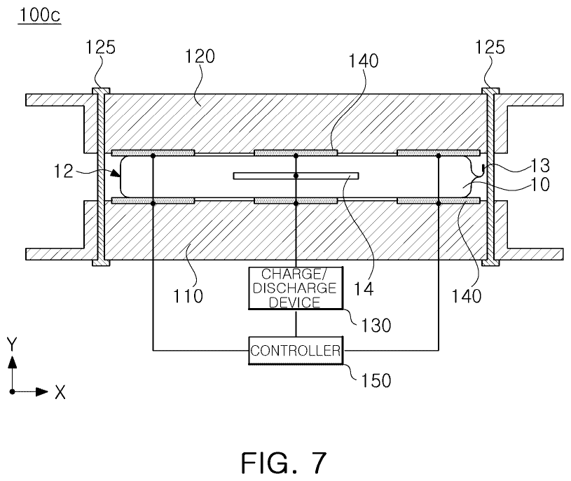

Referring to FIG. 7, the method and the system for detecting a defect in a battery in a formation process according to an embodiment of the present disclosure may measure a pressure in at least one battery cell 10 even without a press device 110 (see FIG. 3A), depending on design.

A volume of at least one battery cell 10 may gradually expand as at least one battery cell 10 is charged. Here, a structure 125 for maintaining an interval between the plurality of support plates 110 and 120 may apply a reaction force for expansion of at least one battery cell 10 to at least one battery cell 10. Accordingly, at least one battery cell 10 may receive a minimum pressure for the plurality of pressure sensors 140 to detect a pressure in at least one battery cell 10. For example, the structure 125 for maintaining the interval may be implemented as a fastening member such as a bolt or a screw, and is not limited thereto.

As set forth above, the method and the system for detecting a defect in a battery in a formation process according to an embodiment of the present disclosure may efficiently detect a defect (e.g., a foreign substance in the battery) occurring in the battery in the formation process (e.g., the efficiency achieved by utilizing a portion of the formation process system for detecting the battery defect and the reduction of time required for the defect detection), and may detect the battery defect early (e.g., earlier than the post-process (the EoL process) of the battery).

Only specific examples of implementations of certain embodiments are described. Variations, improvements and enhancements of the disclosed embodiments and other embodiments may be made based on the disclosure of this patent document.

What is claimed is:

1. A method for detecting a defect in a battery in a formation process, the method comprising:
charging or discharging at least one battery cell in the formation process;
measuring a pressure in the at least one battery cell or a differentiation (dP/dQ) of the pressure with respect to charge when the at least one battery cell is charged or discharged; and
generating data on whether the at least one battery cell has a defect based on the differentiation (dP/dQ).

2. The method of claim 1, wherein the data includes data on whether negative-electrodesalt occurs in the at least one battery cell, and
the generating the data includes generating data indicating that negative-electrode salt occurs in a negative electrode of the at least one battery cell when the differentiation (dP/dQ) is greater than a reference value or a rate of change of differentiation (dP/dQ) is greater than a reference rate of change.

3. The method of claim 2, wherein the generating the data includes generating the data indicating that negative-electrode salt occurs in the negative electrode of the at least one battery cell when the differentiation (dP/dQ) is greater than the reference value within a capacity range in which the differentiation (dP/dQ) is stabilized.

4. The method of claim 2, wherein the generating the data includes generating the data indicating that negative-electrode salt occurs in the negative electrode of the at least one battery cell when the rate of change of differentiation (dP/dQ) is greater than the reference rate of change within a capacity range in which the differentiation (dP/dQ) is stabilized.

5. The method of claim 1, wherein the differentiation (dP/dQ) includes a differentiation of the pressure with respect to charge of the charging, and
the measuring includes monitoring the pressure and charge amount of the at least one battery cell when the at least one battery cell is charged, and measuring the differentiation by dividing a rate of change of pressure by a rate of change of charge amount.

6. The method of claim 1, wherein the charging or discharging includes a press pre-charge (PPC) for performing the pressing and charging of the at least one battery cell together, and charging or discharging the at least one battery cell after the PPC, and
the measuring includes measuring the pressure in the at least one battery cell or the differentiation (dP/dQ) when the PPC is performed.

7. The method of claim 1, wherein the charging or discharging includes a pre-charge of the at least one battery cell, and charging or discharging of the at least one battery cell after the pre-charge, and
the measuring includes measuring the pressure in the at least one battery cell or the differentiation (dP/dQ) when at least one of the pre-charge, the charging or the discharging is performed.

8. The method of claim 1, further comprising:
formation finishing for performing at least one of aging for stabilizing the at least one battery cell or degassing for removing gas inside the at least one battery cell after the measuring.

9. The method of claim 8, further comprising:
controlling the formation finishing for a defective battery cell to be stopped when data indicating that the at least one battery cell is defective is generated in the generating the data.

10. The method of claim 1, further comprising:
manufacturing the at least one battery cell by coupling battery electrodes to a battery case, and injecting an electrolyte into the battery case prior to the charging or discharging.

11. A system for detecting a defect in a battery in a formation process, the system comprising:
a charge/discharge device for charging or discharging at least one battery cell undergoing the formation process;
a pressure sensor for measuring a pressure in the at least one battery cell; and
a controller for generating data on whether the at least one battery cell has a defect based on a differentiation (dP/dQ) of pressure with respect to charge.

12. The system of claim 11, wherein the data includes data on whether negative-electrode salt occurs in the at least one battery cell, and
the controller generates data indicating that negative-electrode salt occurs in a negative electrode of the at least one battery cell when the differentiation (dP/dQ) is greater than a reference value or a rate of change of differentiation (dP/dQ) is greater than a reference rate of change.

13. The system of claim 12, wherein the controller generates the data indicating that negative-electrode salt occurs in the negative electrode of the at least one battery cell when the differentiation (dP/dQ) is greater than the reference value within a capacity range in which the differentiation (dP/dQ) is stabilized.

14. The system of claim 12, wherein the controller generates the data indicating that negative-electrode salt occurs in the negative electrode of the at least one battery cell when the rate of change of differentiation (dP/dQ) is greater than the reference rate of change within a capacity range in which the differentiation (dP/dQ) is stabilized.

15. The system of claim 11, wherein the differentiation (dP/dQ) includes a differentiation of the pressure with respect to charge of the charging, and
the controller monitors the pressure and charge amount of the at least one battery cell when the at least one battery cell is charged, and measures the differentiation by dividing a rate of change of pressure by a rate of change of charge amount.

16. The system of claim 11, further comprising:
a plurality of support plates between which the at least one battery cell is disposed; and
a press device for pressing the plurality of support plates when the at least one battery cell is charged or discharged.

17. The system of claim 11, wherein the pressure sensor is implemented as a plurality of pressure sensors for measuring pressures in a plurality of regions of the at least one battery cell, and
the controller generates the data on whether the at least one battery cell has a defect based on the differentiation (dP/dQ) of a comprehensive pressure with respect to charge in the plurality of regions.
